(19) United States
(12) Patent Application Publication
(10) Pub. No.: US 2026/0280713 A1
(43) Pub. Date: Sep. 17, 2026

(54) OPTICAL LINE TERMINATION POWER SAVING MODE

(71) Applicant: Verizon Patent and Licensing Inc., Basking Ridge, NJ (US)

(72) Inventors: Denis A Khotimsky, Westborough, MA (US); David J Baker, Mechanicsville, VA (US); Gregory K Sherrill, Herndon, VA (US)

(21) Appl. No.: 19/079,726

(22) Filed: Mar. 14, 2025

(51) Int. Cl. H04B 10/27; H04J 14/02; H04L 69/22

(52) U.S. Cl. CPC H04B 10/27; H04J 14/0227; H04L 69/22

(57) ABSTRACT

An example method includes sending a first downstream frame of a downstream optical signal on a first communication interface. The first downstream frame includes an indicator for a low-power operation interval. The low-power operation interval of the downstream optical signal is implemented on the first communication interface. A second downstream frame of the downstream optical signal is sent on the first communication interface after the low-power operation interval. The second downstream frame includes a preamble.

### BACKGROUND

A passive optical network (PON) system uses a point-to-multipoint optical distribution network (ODN) to provide connectivity between a central node known as an Optical Line Termination (OLT) and a number of premises nodes (known equivalently as Optical Network Units (ONUs) or Optical Network Terminals (ONTs)) using bi-directional wavelength channels. A PON protocol (associated with a PON system) promotes precisely timed transmission bursts of individual ONUs towards the OLT so that they do not interfere with each other.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram of an optical communication system, according to some embodiments.

FIG. 2 is an upstream transmission diagram, according to some embodiments.

FIG. 3A is a downstream transmission diagram, according to some embodiments.

FIG. 3B is a diagram illustrating contents of a physical layer frame payload block, according to some embodiments.

FIG. 4 is a diagram of example components of a device, in accordance with some embodiments.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

According to some embodiments, an example method includes sending a first downstream frame of a downstream optical signal on a first communication interface. The first downstream frame includes an indicator for a low-power operation interval. The low-power operation interval of the downstream optical signal is implemented on the first communication interface. A second downstream frame of the downstream optical signal is sent on the first communication interface after the low-power operation interval. The second downstream frame includes a preamble.

In a single-wavelength, time division multiplexing (TDM)/time division multiple access (TDMA) passive optical network (PON) system (e.g., ITU-T G.984 G-PON, G.987 XG-PON, or the like), an optical network unit (ONU) operates over a single, fixed wavelength channel associated with a particular optical line terminal channel termination (OLT CT) over a single optical distribution network (ODN). The TDM/TDMA system can include a single OLT CT and multiple ONUs interconnected by an ODN that includes an optical feeder fiber (also known as a trunk fiber), a splitter, and multiple distribution fibers. The TDM/TDMA PON system can operate over a single bi-directional wavelength channel, where the bidirectional wavelength channel can include a fixed downstream wavelength and a fixed upstream wavelength. The ONUs can support one common fixed downstream wavelength and one common fixed upstream wavelength, forming a single bidirectional wavelength channel.

Once a particular ONU is powered up and physically connected to the ODN with an optical fiber, it has to undergo an activation process that comprises the phases of attaining downstream synchronization, parameter learning, discovery, and ranging. For example, prior to transmitting upstream in the TDM/TDMA PON system, the particular ONU can be required to learn parameters (e.g., upstream burst profile parameters) of an upstream burst (e.g., a preamble, delimiter sizes and patterns, or the like) that the OLT CT provides in a downstream broadcast management message.

As used herein, a transmission (e.g., a downstream transmission and/or an upstream transmission) can refer to an act of transmitting an optical signal or signals over the fiber by a transmitter (e.g., a downstream transmission provided by an OLT CT toward an ONU(s) or an upstream transmission provided by an ONU(s) toward an OLT CT). Additionally, as used herein, a downstream burst can refer to the sequence of physical frames transmitted by the OLT CT with intermittent low-power intervals and restart preambles. Additionally, as used herein, an upstream burst can refer to a time-bounded optical signal transmitted by an ONU.

In a time and wavelength division multiplexing (TWDM) PON system, an ONU can operate on multiple wavelength channels (e.g., one wavelength channel at a time). Each wavelength channel can be associated with a corresponding OLT CT, and the multiple wavelength channels can be multiplexed over a single ODN. The OLT CTs that form the TWDM PON system can physically belong to the same module within a single OLT, to different modules within a single OLT, or to different OLTs.

The multiple ONUs in a TWDM PON system can operate on a particular wavelength channel at any given time and can utilize TDM/TDMA mechanisms. An ONU in a TWDM PON system can be instructed by the OLT CT to switch from an original wavelength channel to a new wavelength channel. When the OLT CT provides such instructions, the ONU can leave multiple ONUs associated with the original wavelength channel, can retune an optical transceiver to specified downstream and upstream wavelengths, and can join multiple ONUs associated with the new wavelength channel. If a particular ONU loses synchronization with its current OLT CT, the ONU may, after a predetermined delay (e.g., a channel loss delay parameter), switch channels to attempt to re-establish optical communication.

In the process of an ONU being newly activated or reactivated on a TDM/TDMA PON system, after attaining synchronization and learning the parameters, the ONU can enter a discovery stage of an activation cycle. While in the discovery stage, the ONU can declare its presence to an OLT CT by providing a globally unique identifier of the ONU (i.e., a serial number, a media access control (MAC) address, or the like depending on a standard), and can wait for assignment of an ODN-specific logical identifier (ONU-ID).

Once the OLT CT assigns the logical ID to the ONU, the ONU can enter a ranging stage of the activation cycle. In the ranging stage, the ONU can be requested to perform one or more short upstream transmissions to allow the OLT CT to accurately measure a round-trip delay (e.g., a round-trip optical signal propagation time and a processing time) and to compute an equalization delay (e.g., extra time that the ONU can be required to delay transmission in order to compensate for differences in the round-trip propagation times between ONUs on the same ODN). Once the individual equalization delay is assigned to the ONU, the ONU can enter a regular operation stage, and can remain in the regular operation stage until the ONU is reset (e.g., by a user), is deactivated by the OLT CT, is disabled by the OLT CT, experiences a loss of connectivity to the OLT CT, or the like.

Assigning an equalization delay to an ONU completes the process of that ONU activation. Once the ONU is activated, the OLT CT can begin assigning regular transmission grants to that ONU. A grant can refer to a permission to use a designated time slot for upstream transmission. In this way, the ONUs can provide, to the OLT CT and based on respective grants, upstream bursts that are received serially by the OLT CT, such as in a non-overlapping and non-interfering manner (e.g., in association with a designated time slot of the ONU). The OLT CT computes and transmits the start times and grant sizes to the ONUs periodically, for example, every 125 microseconds.

Embodiments described herein enable an OLT CT to implement a “downstream burst mode” for downstream optical communication to allow the downstream transmission to be temporarily suspended during periods of low data activity thus facilitating power savings in the OLT CT. To resume downstream transmission, the OLT CT sends a preamble used by the ONUs to recover clock frequency and phase of the downstream optical signal and to identify the start boundary of the subsequent downstream physical frame. The OLT CT downstream burst mode can be configured to support legacy ONUs and downstream burst mode aware ONUs.

In accordance with the downstream burst protocol, the OLT CT may send an indicator of low-power operation (e.g., a “Be Right Back” (BRB) message) indicating the start of a low-power operation interval where typical downstream signaling of the OLT CT 102 is reduced (referred to herein as an OFF interval). An ONU that is downstream burst mode aware may respond to the low-power operation indicator by adjusting its operation to avoid channel switching or ONU reactivation that would typically occur in the absence of downstream OLT CT signal. For example, the ONU may increase its channel loss delay parameter to avoid channel switching or ONU reactivation. In an environment which includes legacy ONUs that are not downstream burst mode aware, the OLT CT may use an OFF interval duration that is less than the channel loss delay parameter, so that downstream optical communications are resumed before channel switching or reactivation are initiated by the legacy ONU. In downstream burst mode, the OLT CT retains the set of the discovered ONUs and their parameters assigned during the respective ONU activation across the OFF interval, obviating the need to reactivate the ONUs when downstream optical transmission resumes.

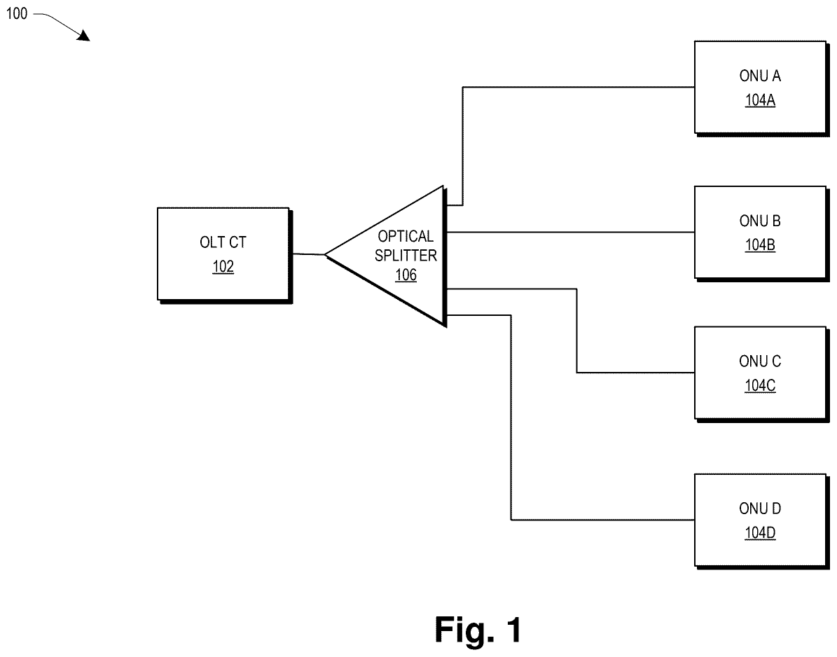

FIG. 1 is a diagram of an optical communication system 100, according to some embodiments. In some embodiments, the optical communication system 100 comprises an OLT CT 102 connected to multiple ONUs 104A, 104B, 104C, 104D via an ODN comprising an optical splitter 106. Based on the different lengths of the fiber connections between the ONUs 104A, 104B, 104C and the OLT CT 102, the upstream bursts have different fiber propagation delays. In some embodiments, the OLT CT 102 performs conversion (e.g. modulation/demodulation) between electrical signals used by service provider equipment and fiber optic signals used by the PON. The OLT CT 102 may coordinate multiplexing between conversion devices on the other end of the passive optical network (e.g., the ONUs 104A, 104B, 104C, 104D).

The ONUs 104A, 104B, 104C, 104D each include one or more devices capable of terminating a PON and providing an interface between the PON and a customer premises. In some implementations, an ONU 104A, 104B, 104C, 104D ONU 280 can provide multiple service interfaces for the customer (e.g., an interface for voice services, an interface for data services, an interface for television services, or the like). The ONUs 104A, 104B, 104C, 104D may provide, to the OLT CT 102 information using upstream optical signals. The ONUs 104A, 104B, 104C, 104D receive downstream optical signals provided by the OLT CT 102, and/or send the downstream electrical signals to devices provided at the customer premises. In some implementations, each ONU 104A, 104B, 104C, 104D can choose a single wavelength channel on which to operate and can switch wavelength channels, if instructed by a respective OLT CT 102.

In some embodiments, the optical splitter 106 includes one or more devices capable of splitting an optical signal (e.g., broadcast or downstream optical signals provided by OLT CT 102) into multiple optical signals. For example, the optical splitter 106 may receive a single downstream optical signal, split the downstream optical signal into multiple reduced-power copies thereof, and provide a copy of the downstream optical signal to the ONUs 104A, 104B, 104C, 104D. In some embodiments, the optical splitter 106 may receive one or more upstream optical signals from the ONUs 104A, 104B, 104C, 104D (e.g., one from each ONU 104A, 104B, 104C, 104D), and pass the combined optical signal to the OLT CT 102.

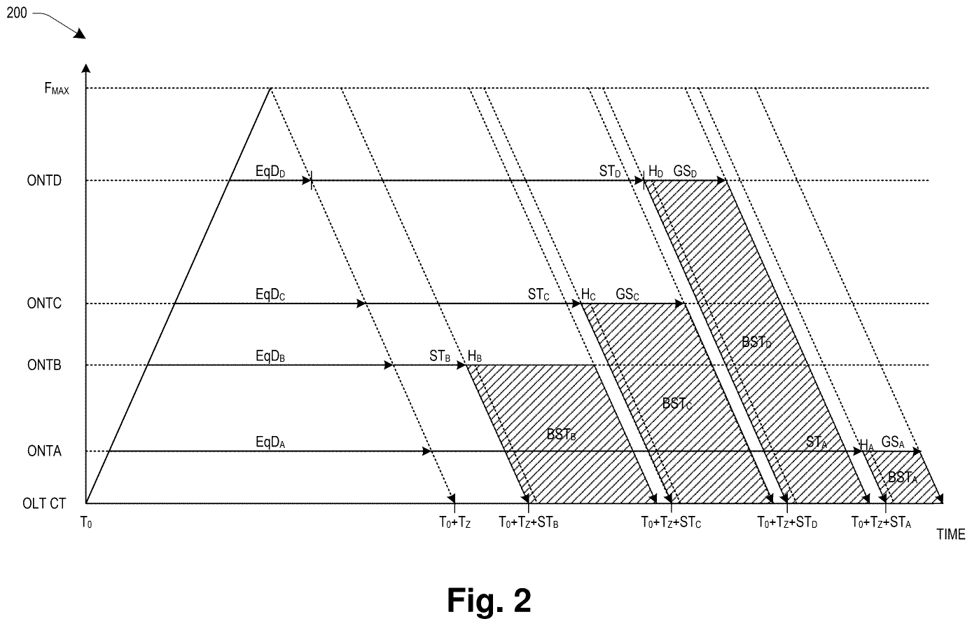

FIG. 2 is an upstream transmission diagram 200 for the optical communication system 100, according to some embodiments. FIG. 2 shows a nominal transmission timing example. As illustrated in FIG. 2, the OLT CT 102 determines an equalization delay (EqD_{A}, EqD_{B}, EqD_{C}, EqD_{D}) for each of the ONUs 104A, 104B, 104C, 104D that measures the delays associated with the different length of the optical fiber connections to the OLT CT 102. The OLT CT 102 may determine the equalization delay for a particular ONU 104A, 104B, 104C, 104D during the ranging phase of an activation period when the ONU 104A, 104B, 104C, 104D attempts to join or rejoin the optical network. The OLT CT 102 assigns start times (ST_{A}, ST_{B}, ST_{C}, ST_{D}) and grant sizes (GS_{A}, GS_{B}, GS_{C}, GS_{D}) to each of the ONUs 104A, 104B, 104C, 104D to time-shift the upstream bursts (BST_{A}, BST_{B}, BST_{C}, BST_{D}) from the ONUs 104A, 104B, 104C, 104D to prevent overlap when received at the OLT CT (indicated by the OLT CT line of the timing diagram). The OLT CT 102 makes these assignments periodically at the start of a physical layer (PHY) frame, represented by T₀. The time T_{z} is the offset of the upstream PHY frame with respect to the downstream PHY frame, also referred to as the upstream frame offset or the “zero-distance equalization delay” since a hypothetical ONU co-located with the OLT CT 102 and thus having zero fiber distance would be assigned the equalization delay equal to T_{z}. Physically, T_{z} is the round-trip propagation time of the optical signal from the OLT CT 102 to a (virtual) reference point at the chosen equivalent equalization fiber distance and back to the OLT CT 102. For example, if the farthest away ONU 104A, 104B, 104C, 104D in the PON has a fiber distance of 20 km, the equalization distance can be approximately 28 km (or more). The difference between the equivalent equalization distance and the fiber distance of the farthest-away ONU 104A, 104B, 104C, 104D is due to finite signal processing time of the ONU 104A, 104B, 104C, 104D. F_{MAX} is the fiber distance of the equivalent equalization point. The process of round-trip optical signal propagation time measurement and equalization delay assignment may be referred to as ranging. In some embodiments, each burst (BST_{A}, BST_{B}, BST_{C}, BST_{D}) has an associated header (H_{A}, H_{B}, H_{C}, H_{D}) formatted according to the protocol of the optical communication system 100 that identifies the sender. The parameters upstream of the transmission diagram 200 represent a bandwidth map established by the OLT CT 102 and communicated to the ONUs 104A, 104B, 104C, 104D at the start of each downstream transmission frame.

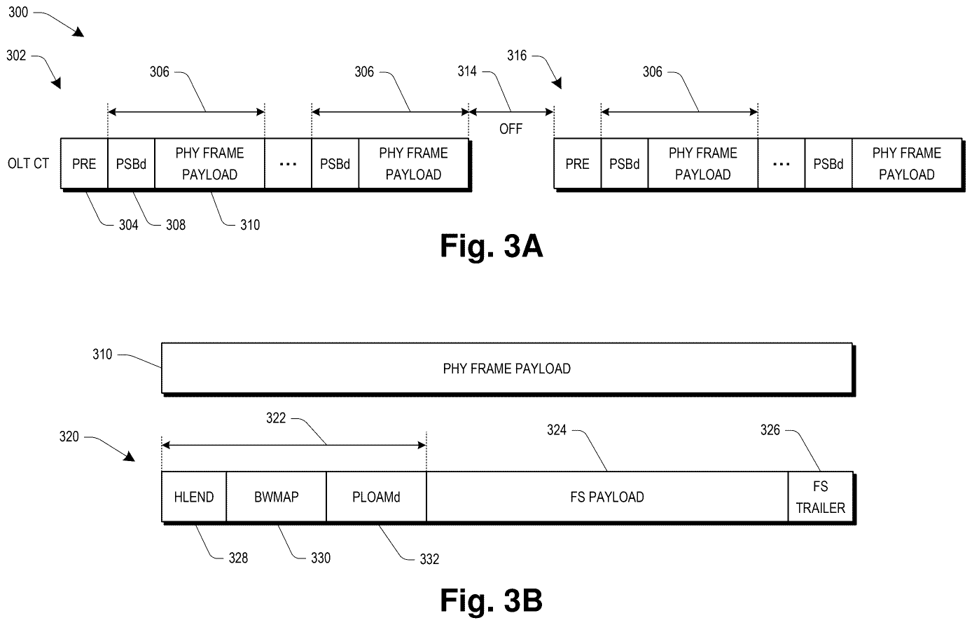

FIG. 3A is a downstream transmission diagram 300 for the optical communication system 100, according to some embodiments. In some embodiments, a first downstream burst 302 comprises a preamble 304 followed by any number of downstream frames 306, each including a physical synchronization (PSBd) block 308 and a physical layer frame payload (PHY FRAME PAYLOAD) block 310. The first eight octets of the PSBd block 308 represent a fixed physical synchronization pattern (PSync), with the second eight octets containing a frame counter (SFC). An ONU 104A, 104B, 104C, 104D derives the clock from the downstream signal, searches for possible alignments of the PSync pattern, and then ensures its periodic repetition.

In some embodiments, the OLT CT 102 pauses the downstream signal in a downstream burst mode to enter a lower power operating mode, resulting in a low-power operation interval, referred to herein as an OFF interval 314. Initiation of the lower power operating mode may be based on the OLT CT 102 identifying a reduced data traffic rate that may be serviced without continuous transmission. The length of the OFF interval 314 may depend on the identified data traffic rate. After the OFF interval 314, the OLT CT 102 resumes transmission with a second downstream burst 316 comprising a preamble 304 followed by any number of downstream frames 306.

FIG. 3B is a diagram illustrating the contents of the PHY FRAME PAYLOAD) block 310, according to some embodiments. In some embodiments, a framing sublayer (FS) generates data for the PHY FRAME PAYLOAD block 306 based on an FS frame 320. The FS frame 320 comprises an FS header 322, an FS payload block 324, and an FS trailer block 326. The FS header 322 includes a length block (HLEND) 328, a bandwidth map (BWMAP) block 330 (e.g., the bandwidth map illustrated in FIG. 2), and a messaging (PLOAMd) block 332. The HLEND block 328 includes fields that define the length of the BWMAP, a message count indicating the number of messages in the PLOAMd block 332, and a header error correction field (HEC). In some embodiments, the FS frame 320 is scrambled to generate the PHY FRAME PAYLOAD block 306.

In some embodiments, one or more of the ONUs 104A, 104B, 104C, 104D may be downstream burst mode aware. The OLT CT 102 may indicate the start of the OFF interval 314 after conclusion of the current downstream frame 302 using a “Be Right Back” (BRB) message. The BRB message may be located in a designated location in the downstream frame, for example, in a broadcast PLOAM message. The BRB message may specify the length of the OFF interval 314. In a TWDM PON system, the ONUs 104A, 104B, 104C, 104D that are downstream burst mode aware may increase the length of the channel loss delay parameter used for identifying a loss of synchronization based on the length of the OFF interval 314 specified in the BRB message to avoid channel switching.

For legacy ONUs 104A, 104B, 104C, 104D that are not downstream burst mode aware, normal channel acquisition protocols are employed to reestablish the communication channel. In some embodiments, the OLT CT 102 may use an OFF interval 314 that is less than the channel loss delay parameter and re-establish downstream optical communication before channel switching is initiated by the legacy ONU 104A, 104B, 104C, 104D.

To facilitate re-synchronization by the ONUs 104A, 104B, 104C, 104D after the OFF interval 314, the OLT CT 102 sends the preamble 304 ahead of the downstream frames 306. In some embodiments, the preamble 304 comprises a clock recovery pattern such as a fast changing optical signal (e.g., modulated by the 0xAA sequence) and a delimiter field that immediately precedes the regular PSync field in the subsequent downstream frame 306. An aware ONU 104A, 104B, 104C, 104D may recover the clock during the preamble 304, and be ready to restore downstream synchronization based on the PSync field after identifying the delimiter field. The OLT CT 102 may also continue to increment the frame counter (SFC) during the OFF interval 314.

An unaware ONU 104A, 104B, 104C, 104D may initiate synchronization based on the clock recovery pattern and the regular PSync field in the subsequent downstream frame 306 according to the standard protocol. It may take the unaware ONU 104A, 104B, 104C, 104D more than one downstream frame to synchronize the channel. In the case where the length of the OFF interval 314 is less than the channel loss delay parameter, the unaware ONU 104A, 104B, 104C, 104D may resynchronize the channel without attempting to change channel frequencies.

The use of the downstream burst mode employing OFF interval 314 and the preamble 304 allows the OLT CT 102 to reduce power consumption without sacrificing channel synchronization.

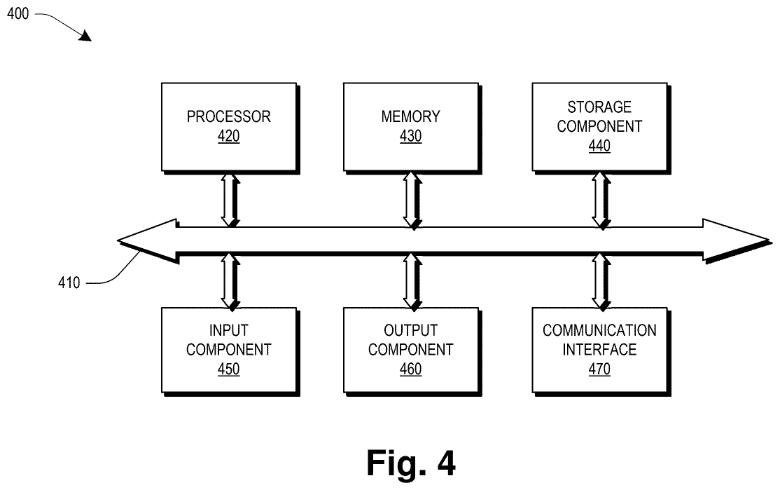

FIG. 4 is a diagram of example components of a device 400, in accordance with some embodiments. The device 400 may correspond to the OLT CT 102 and/or an ONU 104A, 104B, 104C, 104D. In some embodiments, the device 400 comprises a bus 410, a processor 420, a memory 430, a storage component 440, an input component 450, an output component 460, and a communication interface 470.

The bus 410 may include components that permit communication among the components of device 400. The processor 420 may be implemented in hardware, firmware, software or a combination of hardware, firmware, and software. The processor 420 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. The memory 430 may include a random access memory (RAM), a read only memory (ROM), and/or another type of dynamic or static storage device (e.g., a flash memory, a magnetic memory, an optical memory, etc.) that stores information and/or instructions for use by the processor 420.

The storage component 440 may store information and/or software related to the operation and use of device 400. For example, the storage component 440 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

The Input component 450 may include a component that permits the device 400 to receive information, such as via user input (e.g., a touch screen display, a keyboard, a keypad, a mouse, a button, a switch, a microphone, etc.). Additionally, or alternatively, the input component 450 may include a sensor for sensing information (e.g., a global positioning system (GPS) component, an accelerometer, a gyroscope, an actuator, etc.). The output component 460 may include a component that provides output information from the device 400 (e.g., a display, a speaker, one or more light-emitting diodes (LEDs), etc.).

The communication interface 470 may include a transceiver-like component (e.g., a transceiver, a separate receiver and transmitter, etc.) that enables the device 400 to communicate with other devices, such as via a wired connection, a wireless connection, or a combination of wired and wireless connections. The communication interface 470 may permit the device 400 to receive information from another device and/or provide information to another device. For example, the communication interface 470 may include an Ethernet interface, an optical interface, a coaxial interface, an infrared interface, a radio frequency (RF) interface, a universal serial bus (USB) interface, a Wi-Fi interface, a cellular network interface, or the like. In the case of OLT CTs 102 and ONUs 104A, 104B, 104C, 104D, the communications interface 470 may include optical transceivers that send/receive optical signals using the ODN.

The device 400 may perform one or more processes described herein. The device 400 may perform these processes in response to the processor 420 executing software instructions stored by a computer-readable medium, such as the memory 430 and/or the storage component 440. A computer-readable medium is defined herein as a non-transitory memory device. A memory device includes memory space within a single physical storage device or memory space spread across multiple physical storage devices.

Software instructions may be read into the memory 430 and/or the storage component 440 from another computer-readable medium or from another device via the communication interface 470. When executed, software instructions stored in the memory 430 or the storage component 440 may cause the processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An optical unit, comprising:
a communication interface configured to generate a downstream optical signal; and
a processor configured to:
send a first downstream frame of the downstream optical signal on the communication interface, the first downstream frame including an indicator for a low-power operation interval;
implement the low-power operation interval of the downstream optical signal on the communication interface; and
send a second downstream frame of the downstream optical signal on the communication interface after the low-power operation interval, the second downstream frame including a preamble.

2. The optical unit of claim 1, wherein:
the preamble comprises a clock recovery pattern.

3. The optical unit of claim 2, wherein:
the preamble comprises a delimiter field after the clock recovery pattern; and
the delimiter field indicates a start of the second downstream frame.

4. The optical unit of claim 1, wherein:
the indicator comprises a broadcast message.

5. The optical unit of claim 1, wherein:
the indicator specifies a length of the low-power operation interval.

6. The optical unit of claim 1, wherein:
the processor is configured to set a length of the low-power operation interval to be less than a channel loss delay parameter employed by a recipient of the downstream optical signal.

7. The optical unit of claim 1, wherein:
the first downstream frame comprises a bandwidth map associated with an upstream optical signal received on the communication interface; and
the processor is configured to:
employ the bandwidth map in the second downstream frame.

8. An optical unit, comprising:
a communication interface configured to receive a downstream optical signal; and
a processor configured to:
receive a first downstream frame of the downstream optical signal comprising an indicator for a low-power operation interval on the communication interface;
configure a channel loss delay parameter responsive to the indicator; and
receive a second downstream frame of the downstream optical signal on the communication interface after occurrence of the low-power operation interval after the first downstream frame, the second downstream frame including a preamble.

9. The optical unit of claim 8, wherein:
the processor is configured to:
perform a clock recovery for the downstream optical signal based on the preamble.

10. The optical unit of claim 9, wherein:
the preamble comprises a clock recovery pattern, and
the processor is configured to:
perform the clock recovery using the clock recovery pattern.

11. The optical unit of claim 10, wherein:
the preamble comprises a delimiter field after the clock recovery pattern; and
the processor is configured to:
receive the second downstream frame after the delimiter.

12. The optical unit of claim 11, wherein:
the second downstream frame comprises a synchronization field; and
the processor is configured to:
restore downstream synchronization based on the synchronization field after identifying the delimiter field.

13. The optical unit of claim 8, wherein:
the indicator includes a length of the low-power operation interval; and
the processor is configured to:
configure the channel loss delay parameter based on the length of the low-power operation interval.

14. A method, comprising:
sending a first downstream frame of a downstream optical signal on a first communication interface, the first downstream frame including an indicator for a low-power operation interval;
implementing the low-power operation interval of the downstream optical signal on the first communication interface; and
sending a second downstream frame of the downstream optical signal on the first communication interface after the low-power operation interval, the second downstream frame including a preamble.

15. The method of claim 14, comprising:
receiving the preamble on a second communication interface prior to the second downstream frame; and
performing a clock recovery of a device associated with the second communication interface based on the preamble.

16. The method of claim 15, wherein:
the preamble comprises:
a clock recovery pattern; and
a delimiter field after the clock recovery pattern;
performing the clock recovery comprises performing the clock recovery based on the clock recovery pattern; and
the method comprises:
receiving the second downstream frame in the device using the second communication interface after the delimiter.

17. The method of claim 16, wherein:
the second downstream frame comprises a synchronization field; and
the method comprises:
restoring downstream synchronization in the device using the second communication interface based on the synchronization field after identifying the delimiter field.

18. The method of claim 14, comprising:
receiving the indicator on a second communication interface; and
configuring a channel loss delay parameter of a device using the second communication interface responsive to the indicator.

19. The method of claim 18, wherein:
the indicator specifies a length of the low-power operation interval; and
configuring the channel loss delay parameter comprises:
configuring the channel loss delay parameter based on the length of the low-power operation interval.

20. The method of claim 14, wherein:
sending the first downstream frame comprises sending the first downstream frame in a first burst of downstream frames; and
sending the second downstream frame comprises sending the second downstream frame in a second burst of downstream frames.
